(19) United States
(12) Patent Application Publication
(10) Pub. No.: US 2005/0141516 A1
(43) Pub. Date: Jun. 30, 2005

(54) Method and apparatus for using dual free link lists to manage packet memory

(76) Inventors: Ajay K. Sinha, Sacramento, CA (US); Suryakant Maharana, Bangalore (IN)

Correspondence Address: Buckley, Maschoff & Talwalkar LLC, Five Elm Street, New Canaan, CT, 06840, US

(21) Appl. No.: 10/747,806

(22) Filed: Dec. 29, 2003

(51) Int. Cl. H04L 12/56

(52) U.S. Cl. 370/395.7; 370/412

(57) ABSTRACT

A method includes using dual free link lists and may be extendable to use more than two free link lists in managing a packet memory. The method includes providing a multi-port link memory. The link memory contains pointers to storage locations in the packet memory that is to be managed. The method provides for maintaining dual free link lists of free pointers in the link memory pointing to free locations in the packet memory. The free links when used appear as separate linked sets of pointers to storage locations in a packet memory which contains packet data.

### BACKGROUND

In data communication devices such as network switches, routers, network processors or network interface cards, it is customary to store the payloads of incoming and/or outbound data packets in a shared packet memory. The packet memory may be partitioned into a rather large number of relatively small storage locations each of which may store a relatively small portion of the data for a packet.

To aid in managing the packet memory, a separate link memory may be provided. The link memory may store linked lists of pointers to packet memory storage locations in which the data for the packet is stored. The link memory may also store a linked list that indicates which storage locations in the packet memory are “free” (i.e., not currently allocated to storing packet data, and therefore available to satisfy a memory allocation request).

It is a frequently an objective of a data communication device that bandwidth be maximized. Accordingly, the number of memory allocation requests that may be handled per clock cycle should be maximized.

### BRIEF DESCRIPTION OF THE DRAWINGS

FIG. 1 is a simplified block diagram of a router according to some embodiments.

FIG. 2 is a block diagram that illustrates a packet memory management unit that is part of the router of FIG. 1.

FIG. 3 schematically illustrates an example configuration of free link lists as established at the time of initialization in a link memory that is part of the packet memory management unit of FIG. 2.

FIG. 4 is similar to FIG. 3, but showing an example configuration of packet link lists and free link lists as stored in the link memory after a period of operation of the router of FIG. 1.

FIG. 5 is a flow chart that illustrates a process carried out according to some embodiments in a memory controller that is part of the packet memory management unit of FIG. 2.

FIG. 6 is a block diagram which shows an alternative embodiment of at least some aspects of the memory controller shown in FIG. 2.

### DETAILED DESCRIPTION

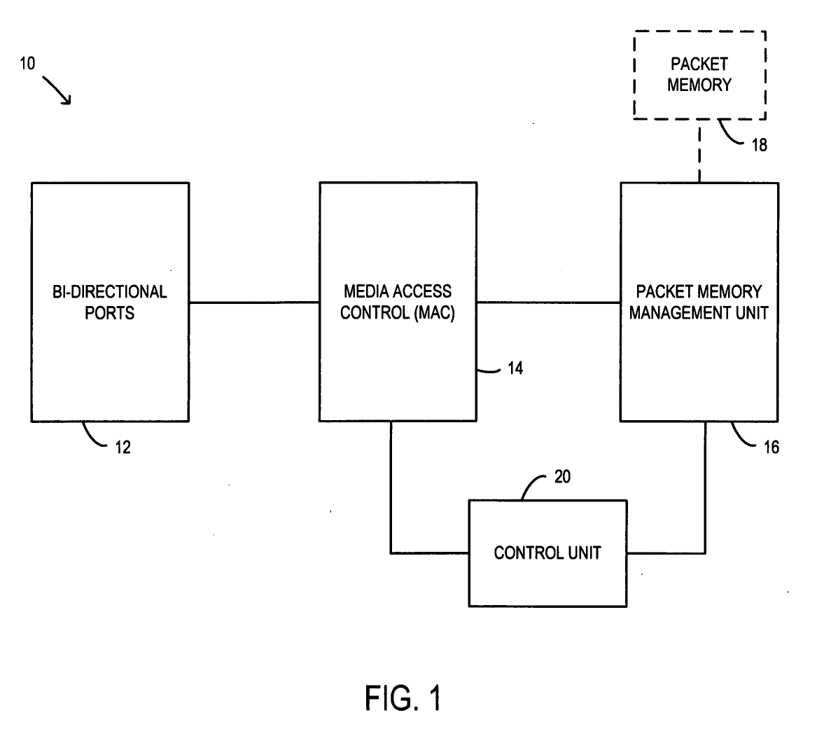

FIG. 1 is a simplified block diagram of a router 10 according to some embodiments.

The router 10 may include a number of bi-directional ports 12 (i.e., ports that may be used to handle both incoming and outbound packets). In other embodiments, the router 10 may include both ports that are dedicated to receiving incoming packets and ports that are dedicated to transmitting outbound packets.

The router 10 may also include a media access control (MAC) unit 14 which is coupled to the ports 12. The MAC unit 14 may control operation of the ports 12 in accordance with conventional principles.

The router 10 may further include a packet memory management unit 16 provided according to some embodiments. The packet memory management unit 16 may be coupled to the MAC unit 14 and may manage storage of packet data in a packet memory and retrieval of packet data from the packet memory. In some embodiments, the packet memory may be provided off-chip (as indicated in phantom at 18) and may be coupled to the packet memory management unit 16. In other embodiments the packet memory may be on-chip and may be integrated with the packet memory management unit.

The router 10 may also include a control unit 20 which generally controls operation of the router 10 and which is coupled to the MAC unit 14 and to the packet memory management unit 16. In addition, the router 10 may include other customary components, which are not shown.

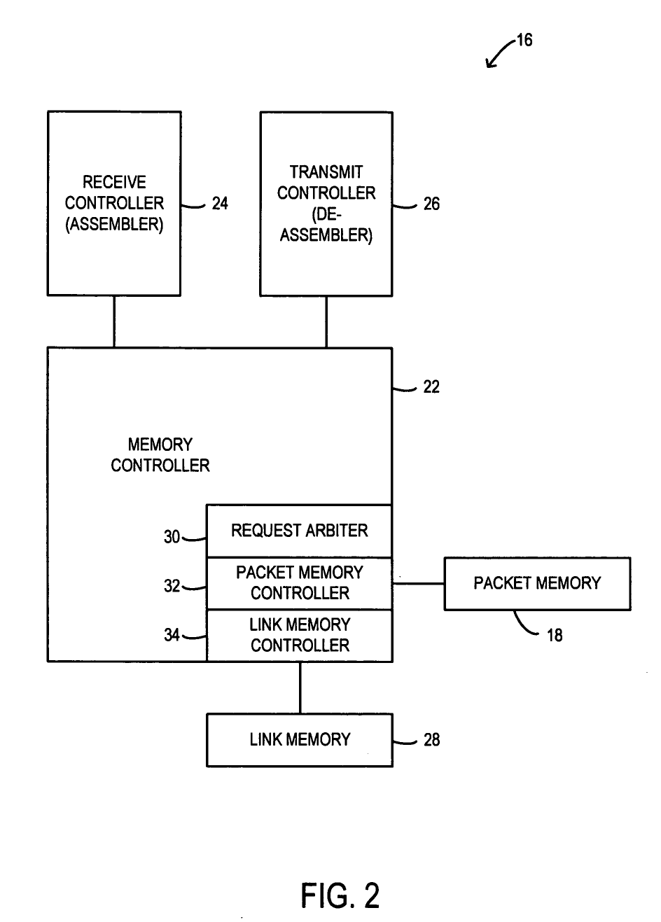

FIG. 2 is a block diagram that illustrates some details of the packet memory management unit 16, as provided according to some embodiments.

As seen from FIG. 2, the packet memory management unit 16 includes a memory controller 22 which is coupled to the packet memory 18. As noted above, the packet memory 18 may be provided off-chip, or may be on-chip and integrated with the packet memory management unit 16. In general, the memory controller 22 operates to store packet data in the packet memory 18 and to retrieve packet data from the packet memory 18. In storing the packet data in the packet memory 18, the memory controller 22 responds to memory allocation requests by placing storage locations in the packet memory in the “allocated (used)” state. In response to requests to retrieve packet data from the packet memory 18, the memory controller 22 retrieves the packet data and places the storage locations in the packet memory 18 in which the packet data was held in a “free” (unallocated) condition. Thus requests to retrieve packet data from the packet memory 18 may also be regarded as (at least in part) requests to free the storage locations in which the packet-data-to-be-retrieved is stored.

The packet memory management unit 16 also includes a receive controller 24 and a transmit controller 26, both of which are coupled to the memory controller 22. The receive controller 24 may operate in accordance with conventional principles to receive packet data (e.g., from the ports 12 (FIG. 1) via the MAC unit 14) and to assemble “chunks” of the packet data, where each chunk is of an appropriate size to be stored in one of the storage locations of the packet memory 18. The transmit controller 26 may operate in accordance with conventional principles to de-assemble chunks of packet data retrieved from the packet memory 18 and to send the retrieved packet data to the ports 12 via the MAC unit 14.

The packet memory management unit 16 also includes a link memory 28 which is coupled to the memory controller 22. The link memory 28 stores link pointers used by the memory controller to control memory access operations with respect to the packet memory 18. Details of how the link memory 28 may be operated in accordance with some embodiments will be described below. In some embodiments, the link memory 28 is a dual port memory that allows simultaneously reading out of data from two storage locations in the link memory 28.

The memory controller 22 may include components such as a request arbiter 30, a packet memory controller 32 and a link memory controller 34. The request arbiter 30 may arbitrate among packet data storage/memory allocation requests and packet data retrieval/link-freeing requests received by the memory controller 22. The packet memory controller 32 may be coupled to the packet memory 18 and may handle packet data storage requests and packet data retrieval requests on the basis of pointers stored in the link memory 28. The link memory controller 34 may be coupled to the link memory 28 and may manage storage of pointers (hereinafter referred to as “link pointers”) in storage locations in the link memory 28. The link memory controller 34 may also manage pointers (hereinafter referred to as “list pointers”) that indicate the heads and tails of link lists maintained in the link memory 28. As will be seen, the link lists come in two varieties, namely packet link lists and free link lists. Both types of link lists are structured as linked lists of link pointers stored in storage locations of the link memory 28.

In some embodiments, two or more free link lists may be maintained in the link memory 28. Each of the two free link lists is for indicating a respective linked set of free (not currently allocated) storage locations in the packet memory 18, with the linked nature of each linked set of free links being a product of pointing relationships within the corresponding free link list. In some embodiments, either one of the free link lists is permitted, from time to time, to point to any storage location in the packet memory 18 (provided of course that a free link list may not at a particular time point to a link that is currently pointed to by another link list). In other words, the packet memory is not partitioned between the free link lists, but rather can be freely shared between the two free link lists. With two free link lists being maintained in the link memory 28, and assuming that the link memory 28 is a dual port memory, the memory controller 22 (and hence the packet memory management unit 16) may be able to consistently handle two memory allocation requests in each clock cycle, if required, without pre-fetching locations of free links.

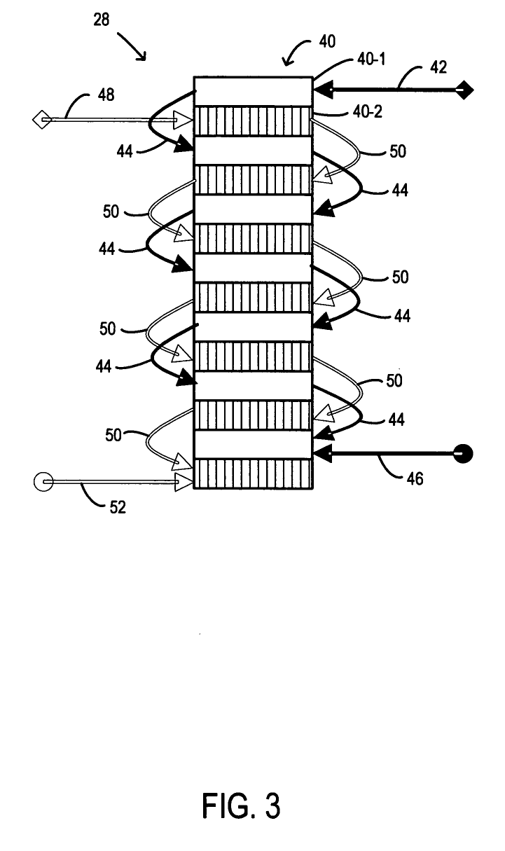

FIG. 3 schematically illustrates an example configuration of free link lists as established at the time of initialization in the link memory 28. In at least one respect FIG. 3 is a simplified representation of the link memory 28, in that the link memory 28 is shown as including only 14 storage locations 40, for purposes of illustration, whereas the actual number of storage locations 40 in the link memory 28 may be equal to the number generated by dividing the total size of usable packet memory by the size of one of its storage locations (all assumed to be the same size) whether this size is logical or physical. The size of each of the locations in link memory is then equal to the number of bits required to represent its total size.

In the example configuration shown in FIG. 3, the unshaded blocks are included in a first free link list (hereinafter “free link list A”) and the vertically shaded blocks are included in a second free link list (hereinafter “free link list B”). Each of the blocks, whether shaded or unshaded, represents a respective storage location 40 of the link memory 28 and stores a respective link pointer. Each of the link pointers indicates a corresponding link in the packet memory 18 and also indicates a corresponding storage location 40 in the link memory 28. The head pointer for free link list A is schematically indicated at 42 in FIG. 3, and may in practice be stored in a register of the link memory controller 34 (FIG. 2). The pointing relationship from each storage location 40 of free link list A to the next storage location 40 of free link list A is indicated by a respective solid arrow 44. The tail pointer for free link list A is schematically indicated at 46 in FIG. 3, and may in practice be stored in a register of the link memory controller 34. The head pointer for free link list B is schematically indicated at 48 in FIG. 3, and may in practice be stored in a register of the link memory controller 34. The pointing relationship from each storage location 40 of free link list B to the next storage location 40 of free link list B is indicated by a respective hollow arrow 50. The tail pointer for free link list B is schematically indicated at 52 in FIG. 3, and may in practice be stored in a register of the link memory controller 34. (It will be appreciated that the head pointers 42, 48 and the tail pointers 46, 52 are “list pointers” as referred to above.)

Because of the pointing of each link pointer stored in a storage location 40 to the next storage location 40 in the same free link list, each free link list takes the form of a linked list, which also indicates a corresponding linked set of storage locations in the packet memory 18. In the example configuration shown in FIG. 3, upon initialization, free link list A starts with the first storage location 40-1 of the link memory 28 and continues on successively through the odd-numbered storage locations 40 of the link memory 28; and free link list B starts with the second storage location 40-2 of the link memory 28 and continues on successively through the even-numbered storage locations 40 of the link memory 28. Other embodiments may employ other configurations of the free link lists upon initialization.

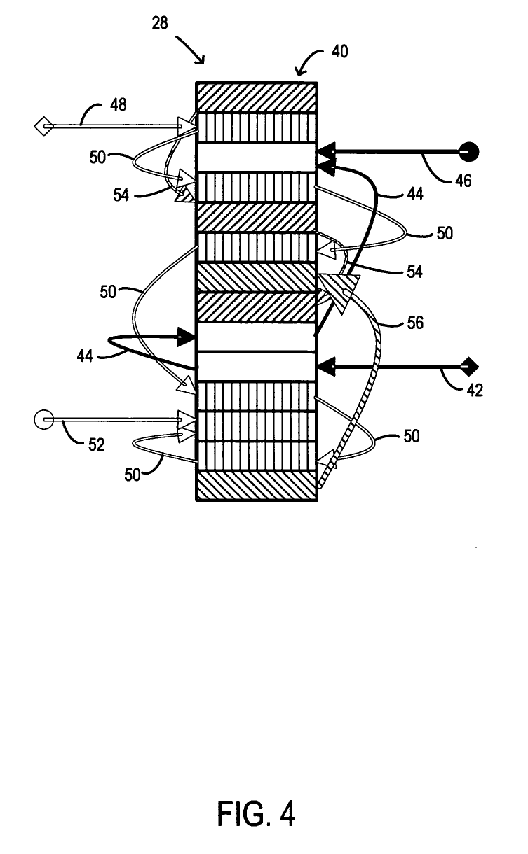

FIG. 4 is a schematic illustration of an example configuration of packet link lists and free link lists as stored in the link memory 28 after a period of operation of the router 10. Each packet link list indicates a respective linked set of storage locations in the packet memory 18, where each of those linked set of links is currently allocated to storing data for a particular packet, and the linked nature of the set of links is a product of pointing relationships within the corresponding packet link list.

In the example configuration shown in FIG. 4, free link lists A and B are still maintained in the link memory 28, but in a rearranged form, as a result of a sequence of allocations of links from, and assignments of freed links to, each of the free link lists. As in FIG. 3: unshaded blocks are included in free link list A; vertically shaded blocks are included in free link list B; the head of free link list A is indicated by pointer 42; the tail of free link list A is indicated by pointer 46; the head of free link list B is indicated by pointer 48; the tail of free link list B is indicated by pointer 52; pointing relationships from one storage location 40 of free link list A to another storage location 40 of free link list A are indicated by solid arrows 44; and pointing relationships from one storage location 40 of free link list B to another storage location 40 of free link list B are indicated by hollow arrows 50.

In the example configuration shown in FIG. 4, two packet link lists are depicted. In practice, as noted above, the link memory 28 and the packet memory 18 may be much larger than literally suggested by FIGS. 3 and 4, and may accommodate storage of a much larger number of packets in packet memory 28. In some embodiments, for example, packet memory 18 and link memory 28 may be sized to accommodate storage of up to 1K packets in packet memory 18 at any given time. Typically, the number of packets stored in packet memory 18 may fluctuate from time to time during operation of the router 10. In any event, the number of packet link lists stored in the link memory 28 may be much larger than the two indicated in FIG. 4.

The two packet link lists depicted in FIG. 4 will be referred to as “packet link list A” and “packet link list B”. The blocks shown as “northeast-southwest” shaded in FIG. 4 are included in packet link list A; and the blocks shown as “northwest-southeast” shaded in FIG. 4 are included in packet link list B. Each storage location 40 of one of the packet link lists may store a link pointer that points to the next storage location 40 of the respective packet link list (and also to the next link in the packet memory for the packet which corresponds to the packet link list). Pointing relationships from one storage location 40 of packet link list A to the next storage location 40 of packet link list A are indicated by “northeast-southwest” shaded arrows 54 in FIG. 4; a pointing relationship from one storage location 40 of packet link list B to the next storage location 40 of packet link list B is indicated by a “northwest-southeast” shaded arrow 56 in FIG. 4. It should be noted that in practice the packet link lists maintained from time to time in the link memory 28 may be substantially larger than as depicted in FIG. 4. Packet link lists may come into existence as packets are newly stored in the packet memory 18 and may cease to exist as packets are retrieved from packet memory 18 and the corresponding links which stored the retrieved packets are freed.

Head and tail information for the packet link list may be stored or calculated by the control unit 20.

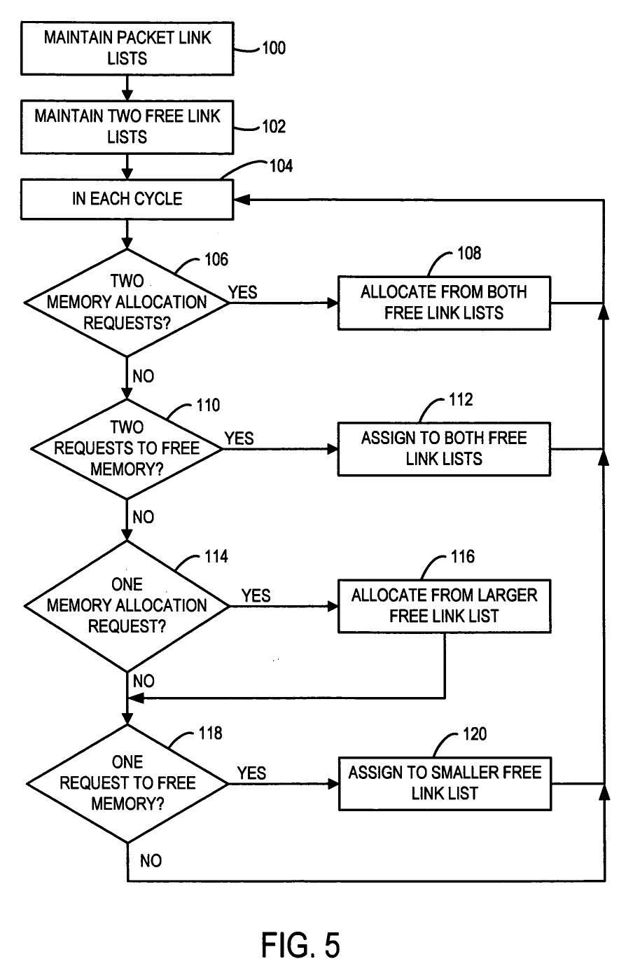

FIG. 5 is a flow chart that illustrates a process carried out according to some embodiments in the memory controller 22.

As indicated at 100 in FIG. 5, the memory controller 22 may maintain a plurality of packet link lists in the link memory 28. As indicated at 102 in FIG. 5, the memory controller 22 may maintain two free link lists in the link memory 28. It will be appreciated that the number as well as the particular configurations of the packet link lists may dynamically change over time as the router 10 operates. The configurations and sizes of the two free link lists A and B may also dynamically change over time as the router 10 operates, but the free link lists A and B continue to be in existence so long as the router 10 is in operation. On occasion the size of the free link lists may be reduced to zero, in which case a stall condition is propagated backwards in the system.

As indicated at 104, the memory controller 22 may perform a process stage for handling packet storage and/or retrieval requests at each clock cycle during operation of the router 10. In a packet memory 18 databus configuration that supports more than one memory allocation request, with a dual port link memory 28 and two free link lists, there are six possible cases for handling in a given clock cycle: (1) handling two memory allocation (packet storage) requests; (2) handling two requests to free memory (packet retrieval requests); (3) handling one memory allocation request and one request to free memory; (4) handling one memory allocation request; (5) handling one request to free memory; and (6) no request to be handled. If the link memory cannot support direct use of its data outputs and inputs and these must be stored, then more (e.g. a plurality) of free link lists can be added depending on how many cycles it takes to get valid data out from the link memory and how many cycles it take to write valid data into the memory and how many ports the link memory has.

At 106 it is determined whether two memory allocation requests are to be serviced in the current clock cycle. If so (case (1)), then as indicated at 108, one of the two requests is serviced by allocating free links in the packet memory 18 pointed to by free link list A, and the other request is serviced by allocating free links in the packet memory 18 pointed to by free link list B. In some embodiments, each of the memory allocations may be made by reference to the head of the respective free link list.

At 110 it is determined whether two requests to free memory are to be serviced in the current clock cycle. If so (case (2)), then as indicated at 112, one of the two requests is serviced by assigning the links freed as a result of the request to free link list A, and the other request is serviced by assigning the links freed as a result of the other request to free link list B. In some embodiments, each assignment of freed links is made to the tail of the respective free link list. In other embodiments, both of the freed sets of links may be assigned to the one of the free link lists that is smaller at the time of the current clock cycle.

At 114 it is determined whether one, and no more than one, memory allocation request is to be serviced in the current clock cycle. If so (case (3) or case (4)), then as indicated at 116, the memory allocation request is serviced by allocating free storage locations in the packet memory 18 pointed to by the one of the free link lists that is larger at the time of the current clock cycle. (The link memory controller keeps a running counter of the number of free links present each cycle in each of the free link lists.)

At 118 it is determined whether one, and no more than one, request to free memory is to be serviced in the current clock cycle. If so (case (3) or case (5)), then as indicated at 120, the request to free memory is serviced by assigning the links freed as a result of the request to the one of the free link lists that is smaller at the time of the current clock cycle.

It will be appreciated that the combined effect of process stages 108 and 116 is that in each clock cycle in which a memory allocation request is serviced, the memory controller 22 allocates links pointed to by one of the free link lists that is at least as large as the other free link list at the time of the clock cycle. (Where two memory allocation requests are serviced in the same clock cycle, the memory controller 22 also allocates links pointed to by the other free link list.) Also, the combined effect of process stages 112 and 120 is that in each clock cycle in which a request to free memory is serviced, the memory controller 22 assigns a freed linked set of storage locations in the packet memory 18 to one of the free link lists that is at least as small as the other free link list at the time of the clock cycle. (Where two requests to free memory are serviced in the same clock cycle, the memory controller 22 may assign the other freed linked set of links to the other free link list.)

In some embodiments, the process illustrated in FIG. 5 may be implemented with hardware (e.g., logic circuitry) as a part of the memory controller 22. It is well within the ability of those who are skilled in the art to provide a hardware design to implement the process of FIG. 5 in view of the guidance provided by the present disclosure and without undue experimentation.

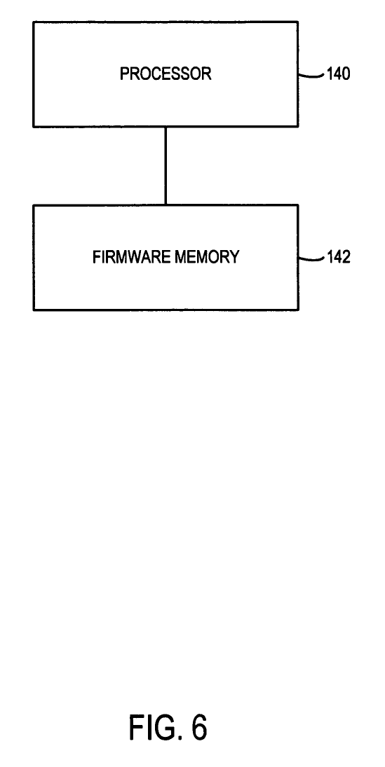

In other embodiments, at least a portion of the memory controller 22 may be constituted by a general purpose processor (indicated by reference numeral 140, FIG. 6) and the process of FIG. 5 may be implemented with suitable software or firmware to control the processor. For example, such software or firmware may be stored in a storage medium such as firmware memory 142 (FIG. 6), which may be coupled to the processor 140.

By providing a dual port link memory, and maintaining two free link lists in the link memory, a packet memory management unit according to some embodiments may be enabled to consistently provide service for two memory allocation requests per clock cycle, as required, without a need to pre-fetch free link locations. Since pre-fetching is not needed, high bandwidth can be reliably achieved, inasmuch as there is no need to rely on availability of free clock cycles to allow for pre-fetching.

In embodiments described above, two free link lists are maintained in a dual port link memory. The teachings of this disclosure can be extended to maintaining more than two free link lists in a multi-port link memory having more than two ports.

The packet memory management unit embodiments described herein may be applied in data communication devices other than routers. For example, such packet memory management unit embodiments may be included in network switches, network processors and network interface cards.

The several embodiments described herein are solely for the purpose of illustration. The various features described herein need not all be used together, and any one or more of those features may be incorporated in a single embodiment. Therefore, persons skilled in the art will recognize from this description that other embodiments may be practiced with various modifications and alterations.

1. A method comprising:
providing a link memory to store linked pointers for controlling access to a packet memory; and
maintaining at least two free link lists in the link memory, each free link list indicating a respective linked set of free storage locations in the packet memory.

2. The method of claim 1, wherein each of the free link lists is permitted to point to any storage location in the packet memory, except that no link in any of the free link lists points to a free link in another free link list.

3. The method of claim 1, wherein each of the free link lists includes a plurality of pointers, each pointer indicating a corresponding storage location in the packet memory and a corresponding storage location in the link memory.

4. The method of claim 1, further comprising:
in each clock cycle in which a memory allocation request is serviced, allocating storage locations from the packet memory that are pointed to by a one of the free link lists that is, at the time of said each clock cycle, at least as large as any other of the free link lists.

5. The method of claim 1, further comprising:
in each clock cycle in which storage locations in the packet memory are freed, assigning a freed linked set of pointers in the link memory to a one of the free link lists that is, at the time of said each clock cycle, at least as small as any other of the free link lists.

6. The method of claim 1, wherein more than two free link lists are maintained in the link memory.

7. An apparatus comprising:
a link memory to store linked pointers for controlling access to a packet memory; and
a memory controller coupled to the link memory and operative to:
maintain at least two free link lists in the link memory, each free link list indicating a respective linked set of free storage locations in the packet memory.

8. The apparatus of claim 7, wherein each of the free link lists is permitted to point to any storage location in the packet memory, except that no link in any of the free link lists points to a free link in another free link list.

9. The apparatus of claim 7, wherein each of the free link lists includes a plurality of pointers, each pointer indicating a corresponding storage location in the packet memory and a corresponding storage location in the link memory.

10. The apparatus of claim 7, wherein, in each clock cycle in which the memory controller services a memory allocation request, the memory controller allocates storage locations from the packet memory that are pointed to by a one of the free link lists that is, at the time of said each clock cycle, at least as large as any other of the free link lists.

11. The apparatus of claim 7, wherein, in each clock cycle in which the memory controller frees storage locations in the packet memory, the memory controller assigns a freed linked set of pointers in the link memory to a one of the free link lists that is, at the time of said each clock cycle, at least as small as any other of the free link lists.

12. The apparatus of claim 7, wherein the link memory is a dual port memory.

13. The apparatus of claim 7, wherein more than two free link lists are maintained in the link memory.

14. A system comprising:
a packet memory to store packet data;
a link memory to store linked pointers for controlling access to the packet memory; and
a memory controller coupled to the link memory and operative to:
maintain at least two free link lists in the link memory, each free link list indicating a respective linked set of free storage locations in the packet memory.

15. The system of claim 14, wherein each of the free link lists is permitted to point to any storage location in the packet memory, except that no link in any of the free link lists points to a free link in another free link list.

16. The system of claim 14, wherein each of the free link lists includes a plurality of pointers, each pointer indicating a corresponding storage location in the packet memory and a corresponding storage location in the link memory.

17. The system of claim 14, wherein, in each clock cycle in which the memory controller services a memory allocation request, the memory controller allocates storage locations from the packet memory that are pointed to by a one of the free link lists that is, at the time of said each clock cycle, at least as large as any other of the free link lists.

18. The system of claim 14, wherein, in each clock cycle in which the memory controller frees storage locations in the packet memory, the memory controller assigns a freed linked set of pointers in the link memory to a one of the free link lists that is, at the time of said each clock cycle, at least as small as any other of the free link lists.

19. The system of claim 14, wherein the link memory is a dual port memory.

20. The system of claim 14, wherein more than two free link lists are maintained in the link memory.

21. An apparatus comprising:
a storage medium having stored thereon instructions that when executed by a machine result in the following:
maintaining at least two free link lists in a link memory, each free link list indicating a respective linked set of free storage locations in a packet memory.

22. The apparatus of claim 21, wherein each of the free link lists is permitted to point to any storage location in the packet memory, except that no link in any of the free link lists points to a free link in another free link list.

23. The apparatus of claim 21, wherein each of the free link lists includes a plurality of pointers, each pointer indicating a corresponding storage location in the packet memory and a corresponding storage location in the link memory.

24. The apparatus of claim 21, wherein the storage medium has stored thereon instructions that when executed by a machine further result in the following:
in each clock cycle in which a memory allocation request is serviced, allocating storage locations from the packet memory that are pointed to by a one of the free link lists that is, at the time of said each clock cycle, at least as large as any other of the free link lists.

25. The apparatus of claim 21, wherein the storage medium has stored thereon instructions that when executed by a machine further result in the following:
in each clock cycle in which storage locations in the packet memory are freed, assigning a freed linked set of pointers in the link memory to a one of the free link lists that is, at the time of said each clock cycle, at least as small as any other of the free link lists.

26. The apparatus of claim 21, wherein the storage medium has stored thereon instructions that when executed by a machine further result in the following:
more than two free link lists are maintained in the link memory.
